(19) United States
(12) Patent Application Publication
(10) Pub. No.: US 2010/0037864 A1
(43) Pub. Date: Feb. 18, 2010

(54) OPERATION OF CAMSHAFTS, PARTICULARLY FOR AN INJECTION PUMP FOR DIESEL, HAVING A RUNNING PULLEY DRIVEN IN A LIFTING MANNER

(76) Inventors: Andreas Dutt, Stuttgart (DE); Gerhard Meier, Schorndorf (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/440,067

(22) PCT Filed: Jul. 23, 2007
(86) PCT No.: PCT/EP07/57555

§ 371 Date: Mar. 5, 2009

(30) Foreign Application Priority Data
Sep. 14, 2006 (DE) 10 2006 043 090.5

(51) Int. Cl. F02M 37/04

(52) U.S. Cl. 123/508

(57) ABSTRACT

The invention provides for operation of camshafts, particularly for an injection pump for diesel. A camshaft rotates around a longitudinal axis of a camshaft. The camshaft has at least one cam being in cooperation with a pressure roller driven in a lifting manner. The pressure roller rotates on the peripheral surface of the cam. The upward stroke of the pressure roller is a working stroke during which the pressure roller moves away from the longitudinal axis of the camshaft. During a return stroke the pressure roller moves toward the longitudinal axis of the camshaft. The peripheral surface of the cam has a return stroke section and a working stroke section. The peripheral surface of the return stoke section has a greater friction value than the working stroke section. Thus an operation of camshafts for an injection pump for diesel is provided, securing a rotation of the pressure roller around the circumference of the cam within the whole speed range of the camshaft.

The present invention relates to a camshaft drive, in particular for a diesel injection pump, which is used to produce a high pressure for diesel fuels in order to supply internal combustion engines.

### PRIOR ART

Patent application DE 35 46 930 C2 has disclosed a camshaft drive, which includes a camshaft that is driven via the crankshaft of the internal combustion engine. The camshaft has a cam along whose circumference a pressure roller rolls. This produces a reciprocating motion in the pressure roller, that moves the pressure roller away from the camshaft longitudinal axis and, on the trailing side of the cam, moves the pressure roller back toward the camshaft longitudinal axis by means of the decreasing cam radius. This produces a continuous reciprocating motion of the pressure roller by means of the rotary motion of the camshaft; the pressure roller is accommodated in a sliding block in order to execute the linear reciprocating motion. The reciprocation thus produced can be utilized to compress the fuel through the use of a valve device. Depending on the design of the diesel injection pump and the provided speed of the camshaft, this injection pump is operated with the speed of the camshaft, which can be as much as 4500 rpm and greater. As a result, the system between the cam and the pressure roller is subjected to a powerful mechanical load due to the dynamics of the rotary/reciprocating motion of the pressure roller.

On the back side of the sliding block, a compression spring is provided, which encompasses the pressure roller and exerts a return stroke force on the pressure roller so that the roller remains in contact with the cam over the entire circumference of the latter. With such an embodiment of a camshaft drive of a diesel injection pump, the problem arises that due to the powerful dynamics in the motion of the pressure roller along the rotating cam, the rotary motion of the camshaft does not assure the rotation of the pressure roller for every angular segment. The cam of the camshaft can be divided into a return stroke section and a working stroke section; the reciprocating motion of the pressure roller compresses the fuel in the working stroke section and refills the compression chamber of the injection pump with fuel in the return stroke section. Over the working stroke section of the cam, forces of up to 10 kN can occur, with which the pressure roller presses against the cam. These forces are not exerted over the return stroke section; only the compression spring presses the pressure roller against the cam. For a reliable operation of the camshaft drive, however, the pressure roller must rest against the cam over every angular segment so that the pressure roller rolls along the circumference surface of the cam. If the force falls below the minimum required to press the pressure roller against the circumference surface of the cam, then the rotary motion of the pressure roller is no longer assured for every section of the cam. The rotary motion of the pressure roller is then able to stop and then the pressure roller remains stationary. A slippage therefore occurs between the pressure roller and the circumference surface of the cam, which leads to a wear on the camshaft drive. The result is a failure of the camshaft drive and therefore a failure of the diesel injection pump.

The object of the present invention, therefore, is to create a camshaft drive for a diesel injection pup that assures a rolling of the pressure roller along the circumference of the cam over the entire speed range of the camshaft.

### DISCLOSURE OF THE INVENTION

This object is attained on the basis of a camshaft drive as recited in the preamble to claim 1 in connection with its defining characteristics. Advantageous modifications of the invention are disclosed in the dependent claims.

The invention includes the technical teaching that the circumference surface of the cam has a return stroke section against which the pressure roller rolls during the return stroke and also has a working stroke section against which the pressure roller rolls during the working stroke; the circumference surface over the return stroke section of the cam has a higher coefficient of friction than it does over the working stroke section.

The invention offers the advantage that an increased coefficient of friction over the return stroke section of the circumference surface of the cam avoids a possible slippage of the pressure roller along the circumference surface in the region of the return stroke section. At the same time, a lower coefficient of friction over the working stroke section is assured by providing a high surface quality of the circumference surface in order to prevent the powerful compressive forces from causing premature wear between the pressure roller and the circumference surface of the cam. Because of the low pressing force of the pressure roller against the circumference surface over the return stroke section, the friction is increased according to the present invention, thus maintaining a rotary motion of the pressure roller over this section as well. The increased roughness over the return stroke section is desirable according to the invention; the increased roughness of the surface and the greater coefficient of friction that this entails does not cause a premature wear because the compressive force of the pressure roller against the return stroke section is comparatively low.

According to an advantageous embodiment of the respective sections over the circumference surface of the cam, the average roughness depth R_{Z} of the return stroke section has a value of at least 2 μm to 8 μm, preferably 3 μm to 6 μm, and particularly preferably, at least 4 μm. The average roughness depth R_{Z} is the average of the individual roughness depths of five successive sections over a roughness profile. The extreme values in each measurement segment are added and the sum of the spans is divided by the number of measurement segments. The resulting roughness depth R_{Z} influences the coefficient of friction of the circumference surface of the cam; a high roughness depth R_{Z} results in a high coefficient of friction.

Preferably, the material ratio M_{R} of the return stroke section has a value of 5% to 30%, preferably from 10% to 25%, and particularly preferably, no more than 20%. The greater the average roughness depth R_{Z} of a surface is, the lower the material ratio M_{R} is. The material ratio M_{R}, which is also referred to as the contact area percentage t_{P}, is the ratio of the contact surface over a certain intersection line to the total area being considered, with regard to the reference span. Consequently a low material ratio M_{R} results in a high friction so that with a low material ratio M_{R} over the return stroke section, it is possible to reduce or avoid a slippage of the pressure roller.

By contrast, the average roughness depth R_{Z} of the working stroke section has a value of 0.1 μm to 2.5 μm, preferably 0.5 μm to 2.2 μm, and particularly preferably, at most 2 μm. The associated material ratio M_{R} of the working stroke section has a value of 20% to 95%, preferably 50% to 90%, and particularly preferably, at least 80%. The low average roughness depth R_{Z} and the resulting high material ratio M_{R} between the pressure roller and the circumference surface over the working stroke section of the cam leads to a low degree of wear because a high surface quality is provided in the working stroke section due to the powerful forces and intense Hertzian pressures involved. Since the possibility of a slippage of the pressure roller over the working stroke section is practically ruled out by the powerful pressing forces, a high surface quality, accompanied by a low average roughness depth and a high material ratio, reduces wear.

According to an advantageous exemplary embodiment of the invention, at least part of the circumference surface of the cam has a surface manufactured by means of a grinding process. It is particularly preferable for at least part of the circumference surface of the cam to have a surface manufactured by means of a polishing process. In this case, the polished surface is limited to the region of the working stroke section. The manufacture of the circumference surface of the cam can take place by means of a grinding process; first, the entire circumference surface of the cam is ground. The surface quality that can be achieved by means of a grinding process is in principle less than the surface quality that can be achieved by means of a polishing process. If the cam is ground over its entire circumference surface and only the region of the working stroke section is subjected to a subsequent polishing, then this yields two sections over the circumference of the cam that have different average roughness depths R_{Z} and therefore different coefficients of friction.

Alternatively, the cam can also be ground and polished over the entire circumference surface; after the polishing, part of the circumference surface in the region of the return stroke section can be roughened again by means of a repeat grinding process. Various grinding processes can be used for the grinding machining of the circumference surface of the cam; a cylindrical surface grinding process is a standard grinding machining of the circumference surface. When this process is used, the grinding structure that forms on the surface of the cam is likewise produced in the circumference direction so that an achievable coefficient of friction between the pressure roller and the cam in the circumference direction turns out to be comparatively low. It is therefore possible for the grinding process for machining the circumference surface in the working stroke section to first include a cylindrical surface grinding process. Then a polishing process is carried out, but not in the return stroke section. The ground surface remains in the return stroke section, but a polished surface is produced in the working stroke section.

Another improvement of the present invention includes a grinding process for machining the circumference surface in the return stroke section; the grinding process involves a grinding direction parallel to the camshaft longitudinal axis. The surface structure produced by the grinding machining is therefore likewise oriented in the direction of the camshaft longitudinal axis so that in the circumference direction, an increase in the friction between the pressure roller and the cam can be achieved. The increased friction is based on the circumference-direction friction force of the pressure roller in relation to the surface of the cam; the grinding structure, however, is oriented in the longitudinal direction The microstructure of the surface that is typical of grinding consequently has a lower coefficient of friction in the grinding direction than perpendicular to the grinding direction. As long as the grinding direction is oriented perpendicular to the rolling motion of the pressure roller over the circumference surface of the cam, this minimizes a possible slippage of the pressure roller in relation to the cam.

Other possibilities for producing different coefficients of friction over different sections of the cam can include coating processes, etching processes, knurling process, or similar processes by means of which the roughness of the surface of a grinding structure is either maintained or produced in the ground or polished surface as a final machining. With regard to the etching process, it is particularly possible to etch the return stroke section in order to achieve an increased coefficient of friction. A surface coating that has a lower roughness depth than the base surface of the coating can be provided for the working stroke section so that the return stroke section is not coated.

The return stroke section and the working stroke section can each extend for 180° around a respective opposite half of a symmetrical cam; the sections of the return stroke and the working stroke can also be limited to only partial segments of the circumference of a cam while the remaining segments adjacent to the return stroke section can likewise correspond to the surface values of the working stroke section.

Other measures that improve the invention will be described in greater detail below together with the description of preferred exemplary embodiments of the invention in conjunction with the drawings.

### EXEMPLARY EMBODIMENTS

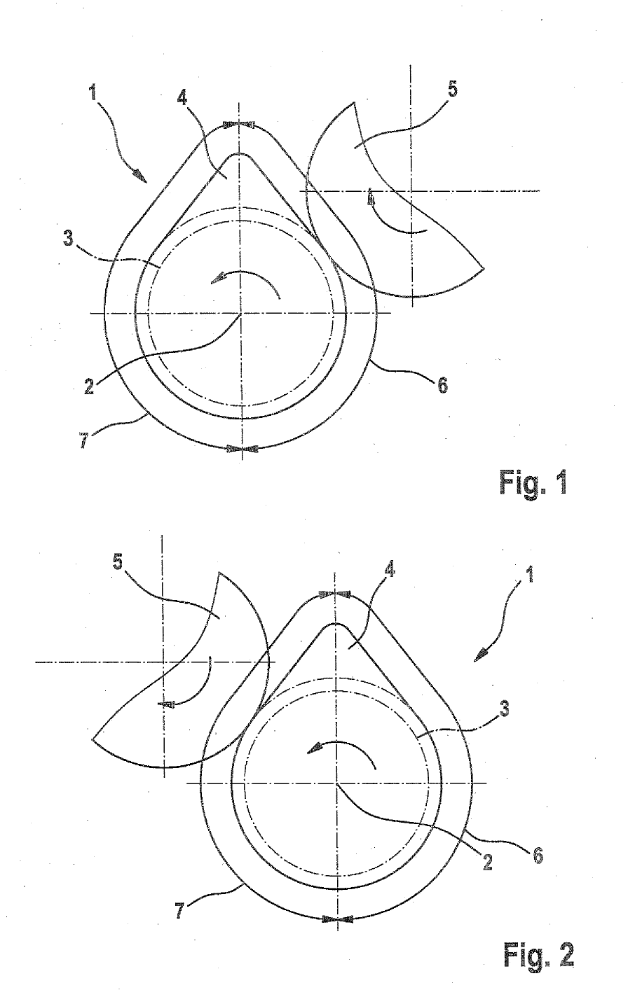

FIG. 1 is a view of a cam and a pressure roller, with a cross-sectional view of the camshaft, with the pressure roller in contact with the return stroke section;

FIG. 2 is a view of a cam and a pressure roller, with a cross-sectional view of the camshaft, with the pressure roller in contact with the working stroke section;

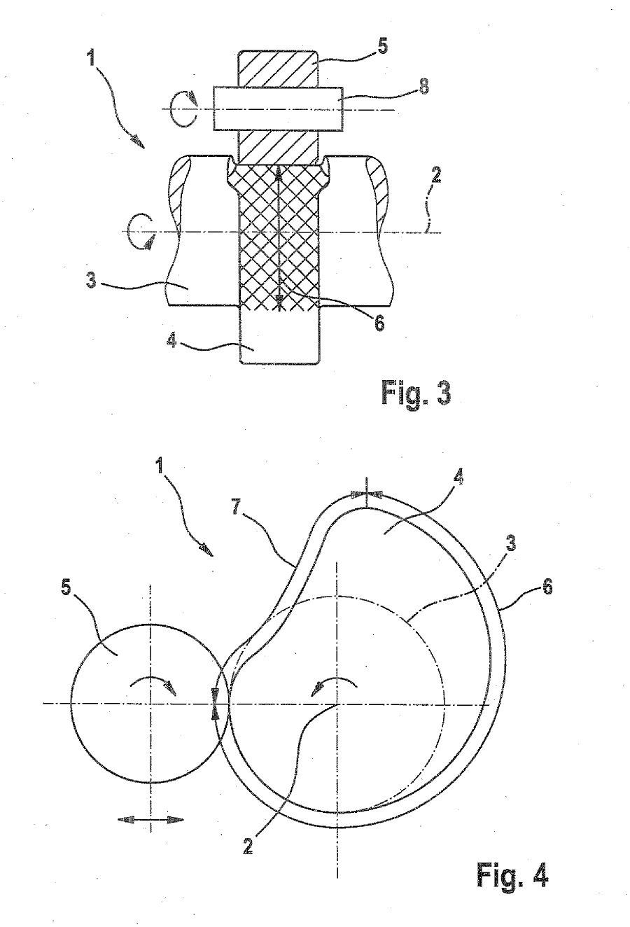

FIG. 3 is a side view of a camshaft with a cam incorporated into it, with the cam brought into contact with a pressure roller;

FIG. 4 is a schematic cross-sectional depiction of an alternative embodiment of a cam, which is brought into contact with a pressure roller; and

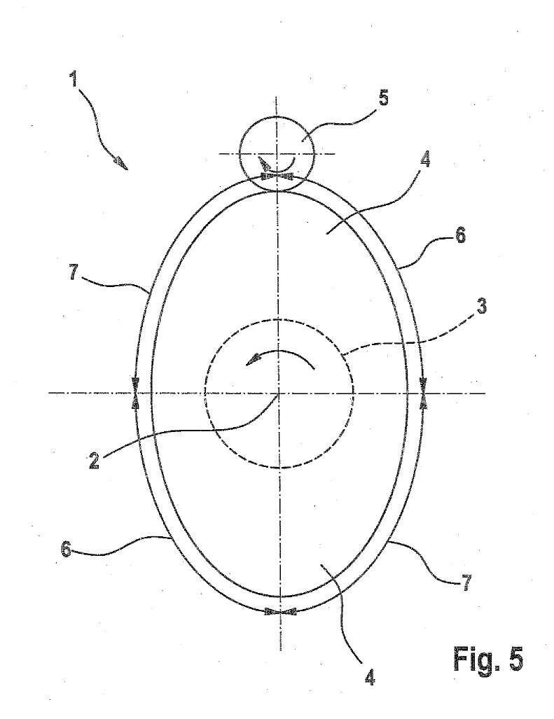

FIG. 5 is a schematic cross-sectional view of a camshaft with a double cam, which is embodied in the form of an ellipse.

In FIGS. 1 and 2, the camshaft drive is labeled with the reference numeral 1. It includes a camshaft 3 that rotates around a camshaft longitudinal axis 2. A cam labeled with the reference numeral 4 is integrated into the camshaft 3; the cam 4 likewise rotates together with the camshaft 3 around the camshaft longitudinal axis 2. The direction of the rotation is indicated by means of an arrow depicted extending around the camshaft longitudinal axis 2. The cam 4 transitions integrally into the region of the cross-section of the camshaft 3; the camshaft 3 and the cam 4 form a common circumferential surface over which a pressure roller 5 rolls. Pressing devices—not shown in detail—press the pressure roller 5 against the circumference surface of the cam 4. Because of the contact of the pressure roller 5 against the circumference surface of the cam 4, the pressure roller 5 is likewise set into rotation; the rotation direction of the pressure roller 5 is likewise indicated by means of an arrow in the figures.

By means of a support—not shown in detail—the pressure roller 5 is guided in a reciprocating fashion; the reciprocating motion moves the pressure roller respectively away from and toward the camshaft longitudinal axis 2. The circumference surface of the cam 4 and camshaft 3 can be divided into a return stroke section 6 and a working stroke section 7. In the depiction shown in FIG. 1, the pressure roller 5 touches the cam 4 in the region of the return stroke section 6, whereas in the depiction shown in FIG. 2, the pressure roller 5 touches the cam 4 in the region of the working stroke section 7. In accordance with the predetermined rotation direction of the cam 4, the pressure roller 5 is moved toward the camshaft longitudinal axis 2 according to the depiction in FIG. 1 since the pressure roller is in contact with the downward-sloping region of the cam 4 in the region of the return stroke section 6.

According to the depiction in FIG. 2, the pressure roller 5 is in contact with the cam 4 in the region of the working stroke section 7 so that with the rotation of the cam 4, the pressure roller 5 moves away from the camshaft longitudinal axis 2. The respective movement of the pressure roller 5 is depicted with a double arrow in FIGS. 1 and 2. The depictions of the sections of the return stroke 6 and working stroke 7 over the circumference of the cam 4 are understood to be merely schematic; it is also possible for the respective section to be limited only to the cam itself and for it not to involve the remaining section of the circumference around the camshaft 3. In any case, according to the invention, in the region of the return stroke section 6, an increased coefficient of friction of the circumference surface is provided, whereas the coefficient of friction in the region of the working stroke section 7 is comparatively low. The different coefficients of friction in the region of the return stroke section 6 as compared to the working stroke section 7 are achieved by means of a different average roughness depths R_{Z} and analogous to this technical value, material ratios M_{R} of the surface. If one follows the rotary motion of the camshaft 3 according to the depictions in FIGS. 1 and 2, then according to FIG. 1, the pressure roller 5 travels over the return stroke section 6 and is pressed with a slight force against the circumference surface of the cam 4. Because of the high average roughness depth R_{Z} in the region of the return stroke section 6, a powerful friction is produced between the cam 4 and the pressure roller 5 so that despite the slight pressing force, the pressure roller 5 rolls along against the cam 4 without slippage. According to the depiction in FIG. 2, the pressure roller 5 rolls against the cam 4 in the region of the working stroke section 7; a low roughness depth permits a minimal-wear contacting of the pressure roller 5 with the cam 4.

FIG. 3 shows another exemplary embodiment of a camshaft drive 1; a cam 4 is incorporated into a camshaft 3, which rotates around a camshaft longitudinal axis 2. A pressure roller 5 is brought into contact with the surface of the cam 4; the pressure roller 5 is supported in rotary fashion by means of a roller pin 8. The region of the return stroke section 6 is depicted by means of cross-hatching, which is merely intended to illustrate the roughened region of the return stroke section 6. According to the span of the roughened region of the return stroke section 6, this section does not extend over half the circumference of the cam 4, but only over a subregion of the half-section of the cam. The remaining region thus corresponds to the surface quality of the working stroke section 7.

FIG. 4 shows an alternative exemplary embodiment of a contour of a cam 4, which is provided on a camshaft 3 and can be rotated around a camshaft longitudinal axis 2. Together with the pressure roller 5, the depiction represents the camshaft drive 1; the reciprocating motion over the circumference of the cam 4 cannot be described as a harmonic motion since the cam 4 has an asymmetrical structure. The working stroke section 7 extends around a first region of the circumference of the cam 4 and the remaining region is depicted as the return stroke section 6. According to this depiction, the region of the high surface quality, which is characterized by means of a very low average roughness depth R_{Z} and a high contact area percentage M_{R}, is only provided over a small subregion of the circumference. The larger subregion of the return stroke section 6 requires a comparatively high roughness depth so as to effectively avoid a slippage of the pressure roller 5.

FIG. 5 shows another exemplary embodiment of a camshaft drive 1. The camshaft 3, which is supported so that it can rotate around the camshaft longitudinal axis 2, has an elliptical contour formed onto it, which has a first and second cam 4. The cams 4 are situated in angular sections offset from each other by 180° so that the pressure roller 5 executes two reciprocating motions with a single rotation of the camshaft 4. There are thus two return stroke sections and two working stroke sections situated sequentially around the circumference of the cams 4. Also according to this exemplary embodiment of a camshaft drive 1, the return stroke sections 6 each have high average roughness depths R_{Z}, while the working stroke sections 7 each have comparatively low average roughness depths R_{Z}.

The embodiment of the invention is not limited to the exemplary embodiments described above. There are instead a number of conceivable variants that make use of the embodiment shown, even with fundamentally different designs. Consequently, the camshaft drive is not limited to an application involving diesel injection pumps, but includes all camshaft drives based on the principal of a pressure roller 5 that rolls along against a cam 4. The span of a return stroke section 6 and of a working stroke section 7 is not limited to the respective half of the circumference surface of the cam 4, but can include subregions that can be distributed in different ways over the circumference of the cam 4.

1-10. (canceled)

11. A camshaft drive, in particular for a diesel injection pump, comprising:
a camshaft that rotates around a camshaft longitudinal axis and includes
at least one cam of the camshaft that cooperates with a pressure roller which is guided in reciprocating motion and which rolls against a circumferential surface of the cam, the reciprocating motion of the pressure roller includes a working stroke in which the pressure roller moves away from the camshaft longitudinal axis and a return stroke in which the pressure roller moves toward the camshaft longitudinal axis, wherein
the circumference surface of the cam has a return stroke section against which the pressure roller rolls during the return stroke and also has a working stroke section against which the pressure roller rolls during the working stroke, and the circumferential surface over the return stroke section of the cam has a higher coefficient of friction than over the working stroke section of the cam.

12. The camshaft drive as recited in claim 11, wherein an average roughness depth of the return stroke section has a value of at least 2 μm to 8 μm, preferably 3 μm to 6 μm, and particularly preferably, at least 4 μm.

13. The camshaft drive as recited in claim 11, wherein an average roughness depth of the working stroke section has a value of 0.1 μm to 2.5 μm, preferably 0.5 μm to 2.2 μm, and particularly preferably, at most 2 μm.

14. The camshaft drive as recited in claim 12, wherein an average roughness depth of the working stroke section has a value of 0.1 μm to 2.5 μm, preferably 0.5 μm to 2.2 82 m, and particularly preferably, at most 2 μm.

15. The camshaft drive as recited in claim 1, wherein a material ratio of the return stroke section has a value of 5% to 30%, preferably from 10% to 25%, and particularly preferably, no more than 20%.

16. The camshaft drive as recited in claim 12, wherein a material ratio of the return stroke section has a value of 5% to 30%, preferably from 10% to 25%, and particularly preferably, no more than 20%.

17. The camshaft drive as recited in claim 13, wherein a material ratio of the return stroke section has a value of 5% to 30%, preferably from 10% to 25%, and particularly preferably, no more than 20%.

18. The camshaft drive as recited in claim 14, wherein a material ratio of the return stroke section has a value of 5% to 30%, preferably from 10% to 25%, and particularly preferably, no more than 20%.

19. The camshaft drive as recited in claim 11, wherein a material ratio of the working stroke section has a value of 20% to 95%, preferably 50% to 90%, and particularly preferably, at least 80%.

20. The camshaft drive as recited in claim 12, wherein a material ratio of the working stroke section has a value of 20% to 95%, preferably 50% to 90%, and particularly preferably, at least 80%.

21. The camshaft drive as recited in claim 13, wherein a material ratio of the working stroke section has a value of 20% to 95%, preferably 50% to 90%, and particularly preferably, at least 80%.

22. The camshaft drive as recited in claim 14, wherein a material ratio of the working stroke section has a value of 20% to 95%, preferably 50% to 90%, and particularly preferably, at least 80%.

23. The camshaft drive as recited in claim 15, wherein a material ratio of the working stroke section has a value of 20% to 95%, preferably 50% to 90%, and particularly preferably, at least 80%.

24. The camshaft drive as recited in claim 16, wherein a material ratio of the working stroke section has a value of 20% to 95%, preferably 50% to 90%, and particularly preferably, at least 80%.

25. The camshaft drive as recited in claim 17, wherein a material ratio of the working stroke section has a value of 20% to 95%, preferably 50% to 90%, and particularly preferably, at least 80%.

26. The camshaft drive as recited in claim 11, wherein at least part of the circumferential surface of the cam includes a surface manufactured by means of a grinding process.

27. The camshaft drive as recited in claim 11, wherein at least part of the circumferential surface of the cam includes a surface manufactured by means of a polishing process.

28. The camshaft drive as recited in claim 27, wherein the polished surface is limited to a region of the working stroke section.

29. The camshaft drive as recited in claim 26, wherein the grinding process for machining the circumferential surface in the working stroke section includes a cylindrical surface grinding process.

30. The camshaft drive as recited in claim 26, wherein the grinding process for machining the circumference surface in the return stroke section includes a grinding direction parallel to the camshaft longitudinal axis.
